(19) United States
(12) Patent Application Publication
(10) Pub. No.: US 2024/0083166 A1
(43) Pub. Date: Mar. 14, 2024

(54) INKJET HEAD AND INKJET RECORDING APPARATUS

(71) Applicant: Toshiba Tec Kabushiki Kaisha, Tokyo (JP)

(72) Inventor: Sota HARADA, Mishima Shizuoka (JP)

(21) Appl. No.: 18/336,844

(22) Filed: Jun. 16, 2023

(30) Foreign Application Priority Data
Sep. 13, 2022 (JP) 2022-145436

(51) Int. Cl. B41J 2/045; B41J 2/14

(52) U.S. Cl. CPC B41J 2/04581; B41J 2/04548; B41J 2/0455; B41J 2/04573; B41J 2/14201; B41J 2002/14491

(57) ABSTRACT

According to an embodiment, an inkjet head includes a piezoelectric element that is configured to change the volume of a pressure chamber from which a liquid is dispensed. A first switch is configured to connect the piezoelectric to a first power line at a first voltage when turned on, and a control circuit is configured to turn on the first switch at a first change time and then turn off the first switch after the voltage of the piezoelectric element reaches the first voltage and then turn on the first switch before a second change time. The control circuit applies a drive waveform to the piezoelectric element in which the voltage of the drive waveform is a second voltage before the first change time, the first voltage after the first change time, and the second voltage after the second change time.

### CROSS-REFERENCE TO RELATED APPLICATION

This application is based upon and claims the benefit of priority from Japanese Patent Application No. 2022-145436, filed Sep. 13, 2022, the entire contents of which are incorporated herein by reference.

### FIELD

Embodiments described herein relate to an inkjet head and an inkjet recording apparatus.

### BACKGROUND

Some inkjet heads dispense ink droplets from a nozzle connected to a pressure chamber by applying a drive waveform to a piezoelectric element that drives (expands/contracts) the pressure chamber. The inkjet head applies a voltage to the piezoelectric element to contract or expand the piezoelectric element which changes the volume of the pressure chamber.

In addition, a coercive electric field is known to eventually reduce the polarizability of the piezoelectric element reducing its performance.

In the related art, the piezoelectric element of the inkjet head is deteriorated by this coercive electric field with use.

### BRIEF DESCRIPTION OF THE DRAWINGS

FIG. 1 is a diagram schematically showing an inkjet recording apparatus according to an embodiment.

FIG. 2 is a block diagram of a control system.

FIG. 3 is a block diagram of an inkjet head.

FIG. 4 is a diagram showing an equivalent circuit for a channel group.

FIG. 5 is a diagram showing an equivalent circuit for a control switch.

FIG. 6 is a timing chart showing an operation example of an inkjet head.

FIG. 7 is a graph showing deterioration of a piezoelectric element in the related art.

FIG. 8 is a graph showing deterioration of a piezoelectric element.

### DETAILED DESCRIPTION

In general, according to one embodiment, an inkjet head and an inkjet recording apparatus capable of avoiding deterioration of a piezoelectric element are provided.

In general, according to one embodiment, an inkjet head includes a piezoelectric element that is configured to change the volume of a pressure chamber. A first switch is configured to connect the piezoelectric to a first power line at a first voltage when turned on, and a control circuit is configured to turn on the first switch at a first change time and then turn off the first switch after the voltage of the piezoelectric element reaches the first voltage and then turn on the first switch before a second change time. The control circuit applies a drive waveform to the piezoelectric element in which the voltage of the drive waveform is a second voltage before the first change time, the first voltage after the first change time, and the second voltage after the second change time.

Hereinafter, certain example embodiments will be described with reference to the drawings.

An inkjet recording apparatus according to an embodiment forms an image on a medium such as a sheet of paper by using an inkjet head. The inkjet recording apparatus dispenses ink droplets from a pressure chamber provided in the inkjet head onto the medium from a nozzle to print the image on the medium. Examples of the inkjet recording apparatus include an office inkjet printer, a bar code inkjet printing apparatus, a point-of-sale (POS) terminal inkjet receipt printer, an industrial inkjet printer, and a 3D inkjet printer. The medium on which the inkjet recording apparatus forms the image is not limited to any specific configuration. The inkjet head provided in a printer according to an embodiment is an example of a liquid dispensing head, and an ink is an example of a liquid dispensed by such a head.

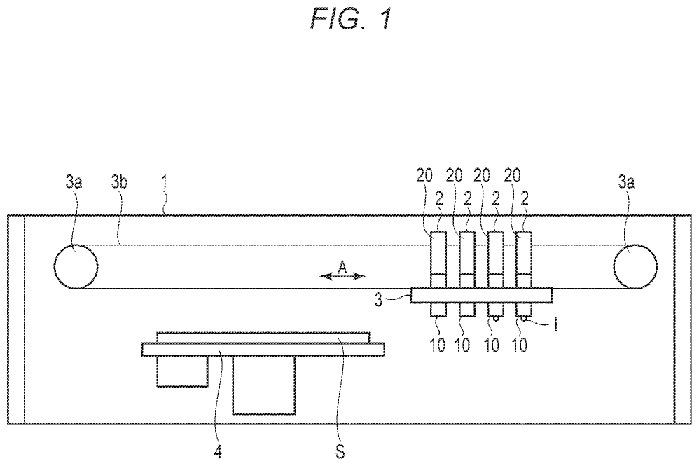

FIG. 1 is a schematic diagram showing an example of a configuration of an inkjet recording apparatus 1 according to an embodiment. The inkjet recording apparatus 1 forms an image on an image-forming medium S (e.g., a sheet of paper or the like) by using a recording material such as the ink. The inkjet recording apparatus 1 includes, for example, a plurality of liquid dispensing units 2, a head support mechanism 3 that supports the liquid dispensing units 2 and permits movement of the liquid dispensing units 2, and a medium support mechanism 4 (support mechanism) that supports the image-forming medium S and permits movement of the image forming medium. The image-forming medium S can be a sheet made of, for example, paper, cloth, or resin.

As shown in FIG. 1, the plurality of liquid dispensing units 2 are supported by the head support mechanism 3 and arranged in parallel along a predetermined direction. The head support mechanism 3 is attached to an endless belt 3b that is wound around rollers 3a. In the inkjet recording apparatus 1, the head support mechanism 3 can be moved in a main scanning direction A orthogonal to a conveyance direction of the image-forming medium S by rotating the rollers 3a.

The liquid dispensing unit 2 includes therein an inkjet head 10 and a circulation device 20.

The inkjet head 10 dispenses droplets of an ink I onto the image-forming medium S.

The circulation device 20 supplies the ink I to the inkjet head 10 and collects the ink I returned from the inkjet head 10.

The liquid dispensing unit 2 performs a dispensing operation of ejecting the ink I from the inkjet head 10. The inkjet recording apparatus 1 is of, for example, a scanning type in which a desired image is formed on the image-forming medium S by performing the ink dispensing operation while reciprocating the head support mechanism 3 in the main scanning direction A. Alternatively, the inkjet recording apparatus 1 may be of a single-pass type in which the ink dispensing operation is performed without moving the head support mechanism 3. In this case, the rollers 3a and the endless belt 3b need not be provided. In such a case, the head support mechanism 3 can be fixed to, for example, a housing of the inkjet recording apparatus 1.

The plurality of liquid dispensing units 2 dispense, for example, inks of four colors corresponding to cyan, magenta, yellow, and key (black) (CMYK), that is, a cyan ink, a magenta ink, a yellow ink, and a black ink, respectively.

Next, a control system of the inkjet recording apparatus 1 will be described.

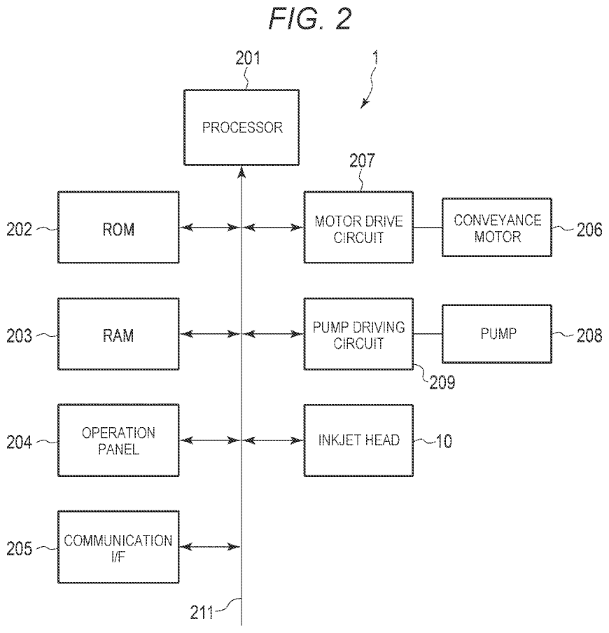

FIG. 2 is a block diagram showing a configuration example of a control system of the inkjet recording apparatus 1.

As shown in FIG. 2, the inkjet recording apparatus 1 includes a processor 201, a ROM 202, a RAM 203, an operation panel 204, a communication interface 205, a conveyance motor 206, a motor drive circuit 207, a pump 208, a pump drive circuit 209, and the inkjet head 10.

The inkjet recording apparatus 1 further includes a bus line 211 such as an address bus and a data bus. The processor 201 is connected, via the bus line 211, to the ROM 202, the RAM 203, the operation panel 204, the communication interface 205, the motor drive circuit 207, the pump drive circuit 209, and the inkjet head 10 directly or via an input and output (I/O) circuit. The motor drive circuit 207 is connected to the conveyance motor 206. The pump drive circuit 209 is connected to the pump 208.

The processor 201 has a function of controlling an overall operation of the inkjet recording apparatus 1. The processor 201 may include an internal cache and various interfaces. The processor 201 implements various types of processing by executing programs stored in the internal cache or the ROM 202. The processor 201 implements various functions of the inkjet recording apparatus 1 according to an operating system and/or an application program.

Some of the various functions implemented by the processor 201 executing the programs as described in the present example may instead be implemented by a dedicated hardware circuit or the like. In this case, the processor 201 controls the function(s) executed by such a hardware circuit.

Further, the processor 201 functions as a host controller of the inkjet head 10.

The ROM 202 is a non-volatile memory in which a control program, control data, and the like are stored in advance. The control program and the control data stored in the ROM 202 can be incorporated in advance according to a design specification of the inkjet recording apparatus 1. For example, the ROM 202 stores an operating system and an application program.

The RAM 203 is a volatile memory. The RAM 203 temporarily stores data being processed by the processor 201. The RAM 203 stores various application programs based on a command from the processor 201. The RAM 203 may also store data necessary for execution of the application program, an execution result of the application program, and the like. Further, the RAM 203 may function as an image memory in which print data is loaded.

The operation panel 204 is an interface that receives an input of an instruction from a user (operator) and displays various types of information to the user (operator). The operation panel 204 includes an operation unit that receives the user input of the instruction and a display unit that displays the information to the user.

Upon user operation of the operation unit, the operation panel 204 transmits a signal indicating the input operation received from the operator to the processor 201. For example, the operation unit includes a function key such as a power key, a sheet feed key, and an error release key.

The operation panel 204 displays the various kinds of information generated or set based on the control of the processor 201. For example, the operation panel 204 displays a present state (condition) of the inkjet recording apparatus 1. For example, the display unit is implemented as a liquid crystal monitor.

The operation unit may be implemented as a touch panel. In this case, the display unit may be integrally formed with the touch panel serving as the operation unit.

The communication interface 205 is an interface for transmitting and receiving data to and from an external device via a network such as a local area network (LAN). For example, the communication interface 205 is an interface that supports LAN connection. For example, the communication interface 205 receives print data from a client terminal via the network. For example, when an error occurs in the inkjet recording apparatus 1, the communication interface 205 transmits an error notification signal to the client terminal.

The motor drive circuit 207 controls driving of the conveyance motor 206 according to a signal from the processor 201. For example, the motor drive circuit 207 transmits a control signal or supplies power to the conveyance motor 206.

The conveyance motor 206 is driven under the control of the motor drive circuit 207. The conveyance motor 206 functions to drive the head support mechanism 3, the medium support mechanism 4, and the like. For example, when the conveyance motor 206 is driven, the medium support mechanism 4 conveys the medium. Further, when the conveyance motor 206 is driven, the head support mechanism 3 moves the inkjet head 10.

The pump drive circuit 209 controls driving of the pump 208 according to a signal from the processor 201. For example, the pump drive circuit 209 transmits power or control signal to the pump 208.

The pump 208 is driven under the control of the pump drive circuit 209. The pump 208 is for circulating the ink I in the circulation device 20. When the pump 208 is driven, the ink I is supplied from the circulation device 20 to the inkjet head 10, and the ink I is also collected (returned) from the inkjet head 10.

The inkjet recording apparatus 1 may further include aspects in addition to those specifically depicted in FIGS. 1 and 2. In other examples, specifically depicted aspects may be excluded from an inkjet recording apparatus 1.

Next, the inkjet head 10 will be described.

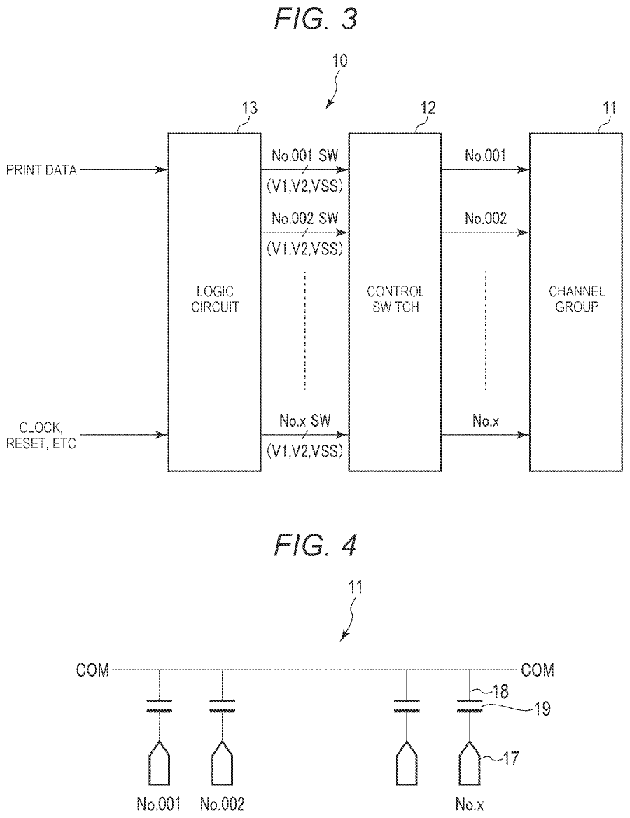

FIG. 3 shows a configuration example of an inkjet head 10. As shown in FIG. 3, the inkjet head 10 includes a channel group 11, a control switch 12, and a logic circuit 13.

The channel group 11 includes a plurality of channels (flow paths) for dispensing the ink. Here, the channel group 11 includes channels No. 001, No. 002, . . . No. x. Each channel includes a pressure chamber that can be filled with the ink, a piezoelectric element that changes a volume of the pressure chamber, and an electrode that applies a voltage to the piezoelectric element.

Each channel receives a drive waveform via the control switch 12. The drive waveform is applied to the piezoelectric element of each channel through the electrode. When the drive waveform is applied to the piezoelectric element, the piezoelectric element is driven to change the volume of the pressure chamber. The ink droplets are dispensed from the nozzle connected to the pressure chamber by a pressure vibration caused by the change in the volume of the pressure chamber.

The control switch 12 is a switch that controls connection between a power line through which the voltage is supplied and the electrode of each channel. The control switch 12 controls the connection between the power line and the electrode for each channel. Here, the control switch 12 controls connection between a power line (referred to in this context as the first power line) through which a voltage V1 is supplied, a power line (referred to in this context as the second power line) through which a voltage V2 is supplied, and a power line (referred to in this context as the third power line) through which a voltage VSS (for example, ground) is supplied, and the electrode of the channel. The control switch 12 switches the connection according to a control signal supplied from the logic circuit 13.

Here, the relationship between these voltages is voltage V1>voltage V2>voltage VSS.

The logic circuit 13 (also referred to as a control circuit) supplies the control signals to the control switch 12. The logic circuit 13 receives the print data and a clock signal and a reset signal. The logic circuit 13 supplies the control signal to the control switch 12 so the drive waveform is appropriately applied to the appropriate channel for purposes of printing the print data. The logic circuit 13 transmits the control signal for controlling the connection between the first to third power lines and the electrode for each channel.

FIG. 4 shows an equivalent circuit for the channel group 11. Here, the channel No. x will be described as representative of all channels. As shown in FIG. 4, the channel No. x includes a first electrode 17, a second electrode 18, and a piezoelectric element 19.

The first electrode 17 is connected to the control switch 12. The first electrode 17 receives the voltage V1, the voltage V2, or the voltage VSS through the control switch 12.

The second electrode 18 is connected to a reference voltage COM.

The piezoelectric element 19 that changes the volume of the pressure chamber is formed between the first electrode 17 and the second electrode 18. A voltage difference between the first electrode 17 and the second electrode 18 can thus be applied to the piezoelectric element 19. In this context, the piezoelectric element 19 corresponds to a capacitor type element.

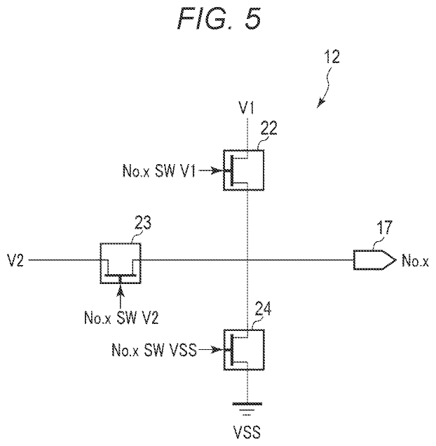

FIG. 5 shows an equivalent circuit for the control switch 12. Here, a switch connected to the channel No. x will be described as representative. As shown in FIG. 5, the control switch 12 includes transistors 22, 23, 24.

The transistor 22 connects the first power line (through which the voltage V1 is supplied) and the first electrode 17. That is, the transistor 22 connects the first power line and the piezoelectric element 19. The transistor 22 has a source connected to the first power line, a drain connected to the first electrode 17, and a gate connected to the logic circuit 13.

The transistor 22 controls the connection between the first power line and the first electrode 17 according to a control signal (No. x SW V1) supplied by the logic circuit 13.

When the transistor 22 is turned on according to the control signal from the logic circuit 13, the first power line and the first electrode 17 are connected. As a result, the voltage V1 is applied to the first electrode 17.

The transistor 23 connects the second power line (through which the voltage V2 is supplied) and the first electrode 17. That is, the transistor 23 connects the second power line and the piezoelectric element 19. The transistor 23 has a source connected to the second power line, a drain connected to the first electrode 17, and a gate connected to the logic circuit 13.

When the transistor 23 is turned on based on a control signal (No. x SW V2) from the logic circuit 13, the second power line and the first electrode 17 are connected. As a result, the voltage V2 is applied to the first electrode 17.

The transistor 24 connects the third power line (through which the voltage VSS is supplied) and the first electrode 17. That is, the transistor 24 connects the third power line and the piezoelectric element 19. The transistor 24 has a source connected to the third power line, a drain connected to the first electrode 17, and a gate connected to the logic circuit 13.

When the transistor 24 is turned on based on a control signal (No. x SW VSS) from the logic circuit 13, the third power line and the first electrode 17 are connected. As a result, the voltage VSS is applied to the first electrode 17.

The drains of the transistors 22, 23, 24 are connected with one another.

When the transistors 22, 23, 24 are turned off based on the control signals from the logic circuit 13, the first electrode 17 has a high impedance.

The control switch 12 has transistors 22, 2324 for each separate channel.

Next, an operation example of the inkjet head 10 will be described.

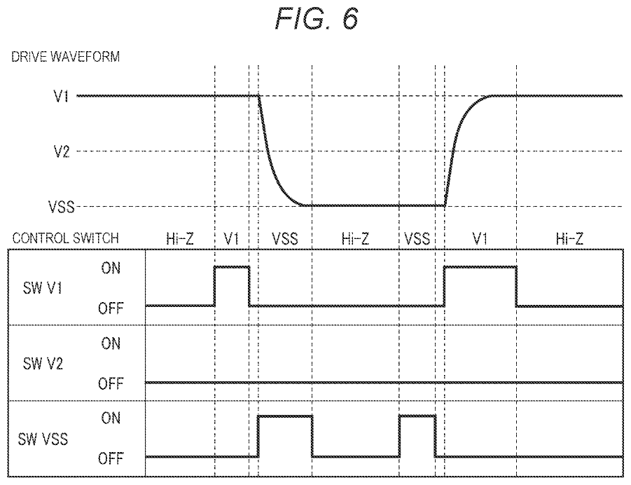

FIG. 6 is a timing chart showing an operation example of the inkjet head 10. FIG. 6 shows an operation example in which the drive waveform applied to the piezoelectric element 19 of a predetermined channel is generated.

FIG. 6 shows the signal values for SW V1, SW V2, and SW VSS output from the logic circuit 13 and the drive waveform applied to the piezoelectric element 19. Here, as the drive waveform, the logic circuit 13 applies the voltage VSS to the piezoelectric element 19 after initially applying the voltage V1 to the piezoelectric element 19. After the voltage VSS is applied, the drive waveform applies the voltage V1 again. Whenever a voltage across the piezoelectric element 19 is stabilized, the logic circuit 13 sets the piezoelectric element 19 to a high impedance.

In an initial state, the logic circuit 13 turns off the SW V1, the SW V2, and the SW VSS. Furthermore, in this initial state, the voltage V1 is being applied to the piezoelectric element 19 (that is, the first electrode 17). In this context, the reference voltage COM is 0.

The logic circuit 13 turns on the SW V1 before a first change time the voltage applied to the piezoelectric element 19 is changed from the voltage V1 to the voltage VSS. When the SW V1 is turned on, the voltage V1 is applied to the piezoelectric element 19. By this operation, the voltage of the piezoelectric element 19 returns to the voltage V1 even if electric charges of the piezoelectric element 19 were partially discharged and the voltage has reduced.

When a predetermined period elapses after the SW V1 was turned on, the logic circuit 13 turns off the SW V1. At this time, all of the SW V1, the SW V2, and the SW VSS are temporarily turned off. By this operation, the logic circuit 13 prevents the first power line, the second power line, and the third power line from being short-circuited.

When the predetermined period elapses (when a first change time is reached) after the SW V1 was turned off, the logic circuit 13 turns on the SW VSS. When the logic circuit 13 turns on the SW VSS, the voltage applied to the piezoelectric element 19 drops from the voltage V1 to the voltage VSS.

The logic circuit 13 waits until the voltage applied to the piezoelectric element 19 becomes the voltage VSS (a difference between the voltage applied to the piezoelectric element 19 and the voltage VSS becomes a predetermined threshold or less). At a predetermined timing after the voltage applied to the piezoelectric element 19 reaches the voltage VSS, the logic circuit 13 turns off the SW VSS. That is, the logic circuit 13 sets the piezoelectric element 19 to a high impedance.

When the SW VSS is turned off, the logic circuit 13 turns on the SW VSS before a second change time at which the voltage applied to the piezoelectric element 19 is changed from the voltage VSS to the voltage V1.

When a predetermined period elapses after the SW VSS is turned on, the logic circuit 13 turns off the SW VSS.

When a predetermined period elapses (when the second change time is reached) after the SW VSS was turned off, the logic circuit 13 turns on the SW V1. When the logic circuit 13 turns on the SW V1, the voltage applied to the piezoelectric element 19 rises from the voltage VSS to the voltage V1.

The logic circuit 13 waits until the voltage applied to the piezoelectric element 19 reaches the voltage V1 (a difference between the voltage applied to the piezoelectric element 19 and the voltage V1 becomes a predetermined threshold or less). At a predetermined time after the voltage applied to the piezoelectric element 19 reaches the voltage V1, the logic circuit 13 turns off the SW V1. That is, the logic circuit 13 sets the piezoelectric element 19 to a high impedance.

Next, possible deterioration of a piezoelectric element 19 will be described.

When the piezoelectric element 19 deteriorates, an electrostatic capacity of the piezoelectric element 19 decreases.

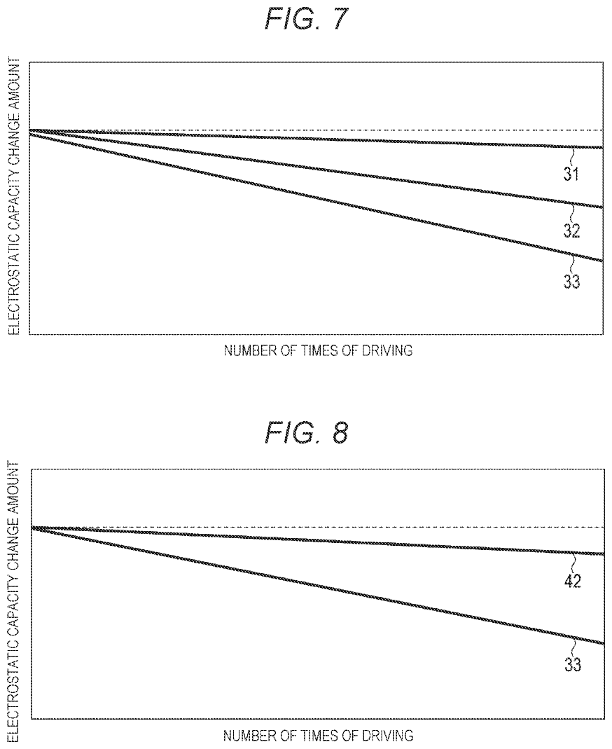

FIG. 7 shows deterioration of a piezoelectric element 19 in the related art. FIG. 7 shows an example of a case where the application of the voltage to the first electrode 17 continues even after the voltage applied to the piezoelectric element 19 has stabilized.

In FIG. 7, the horizontal axis indicates the number of times (on a logarithmic scale) the drive waveform has been applied to the piezoelectric element 19. The vertical axis indicates a change in the electrostatic capacity of the piezoelectric element 19.

FIG. 7 shows graphlines 31, 32, 33.

The graphline 31 shows deterioration when a drive waveform whose width is equal to an acoustic length (AL) is applied to the piezoelectric element 19. In this context, the value for the acoustic wavelength (AL) is half a natural vibration period of the pressure in a pressure chamber of the inkjet head 10. For example, a width of the drive waveform is the time period from the first change time to the second change time.

The graphline 32 shows deterioration when a drive waveform whose width is equal to AL×3 (3AL) is applied to the piezoelectric element 19.

The graphline 33 shows deterioration when a drive waveform whose width is AL×5 (5AL) is applied to the piezoelectric element 19.

As shown by the graphline 31, when the width of the drive waveform is AL, the deterioration of the piezoelectric element 19 proceeds relatively slowly. As shown by the graphlines 32 and 33, when the width of the drive waveform is 3AL and 5AL, the deterioration of the piezoelectric element 19 progresses more steeply than that when the width of the drive waveform is AL.

Next, deterioration of the piezoelectric element 19 according to the embodiment will be described.

FIG. 8 shows the deterioration of the piezoelectric element 19 of an embodiment. In FIG. 8, the horizontal axis indicates the number of times (logarithmic scale) the drive waveform has been applied to the piezoelectric element 19. The vertical axis indicates a change amount of an electrostatic capacity of the piezoelectric element 19.

FIG. 8 shows graphlines 33 and 42. The graphline 33 is as described above for FIG. 7.

The graphline 42 shows deterioration when a drive waveform whose width is 5AL is applied to the piezoelectric element 19 according to an embodiment.

As shown by the graphlines 33 and 42, the deterioration of the piezoelectric element 19 in the embodiment is slowed compared to that of the piezoelectric element 19 in the related art.

The logic circuit 13 may change the voltage applied to the piezoelectric element 19 from the voltage V1 to the voltage V2. The logic circuit 13 may further change the voltage applied to the piezoelectric element 19 from the voltage V2 to the voltage VSS.

In the initial state, the voltage VSS may be applied to the piezoelectric element 19.

In other examples, inkjet head 10 need not include the second power line.

The inkjet head 10 may include four or more power lines through which different voltages are supplied.

The inkjet head 10 configured as described above disconnects a piezoelectric element 19 from a power line once the voltage applied to the piezoelectric element 19 has stabilized after the electrode of the piezoelectric element 19 and the power line were connected. As a result, the inkjet head 10 can reduce the time during which the voltage from the power line is applied to the piezoelectric element. Accordingly, the inkjet head 10 can prevent the unnecessary deterioration of the piezoelectric element 19.

In the example of the related art, the deterioration of the piezoelectric element 19 becomes noticeable/substantial a length of the drive waveform becomes 3AL or more. However, the inkjet head 10 according to an embodiment can prevent the deterioration of the piezoelectric element 19 even when the length of the drive waveform is 3AL or more.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An inkjet head, comprising:
a piezoelectric element configured to change a volume of a pressure chamber;
a first switch configured to connect the piezoelectric to a first power line at a first voltage when turned on; and
a control circuit configured to turn on the first switch at a first change time and then turn off the first switch after the voltage of the piezoelectric element reaches the first voltage and then turn on the first switch before a second change time, wherein
the control circuit applies a drive waveform to the piezoelectric element in which the voltage of the drive waveform is a second voltage before the first change time, the first voltage after the first change time, and the second voltage after the second change time.

2. The inkjet head according to claim 1, further comprising:
a second switch configured to connect the piezoelectric element to a second power line at the second voltage when turned on, wherein
the control circuit is configured to turn the second switch on and then off before the first change time.

3. The inkjet head according to claim 1, wherein the control circuit turns the first switch on and off between the first and second change times.

4. The inkjet head according to claim 1, wherein
a length of time between the first and second change times of the drive waveform is at least three acoustic lengths (AL) of the pressure chamber.

5. The inkjet head according to claim 1, wherein
the piezoelectric element includes a first electrode and a second electrode,
the first electrode is connected to the first switch, and
the second electrode is connected to a reference voltage terminal.

6. The inkjet head according to claim 5, further comprising:
a second switch configured to connect the first electrode of the piezoelectric element to a second power line at the second voltage when turned on, wherein
the control circuit is configured to turn the second switch on and then off before the first change time.

7. The inkjet head according to claim 6, further comprising:
a third switch configured to connect the first electrode of the piezoelectric element to a third power line when at a third voltage when turned on, the third voltage being less than the first voltage but greater than the second voltage.

8. The inkjet head according to claim 1, wherein the first switch comprises a transistor.

9. An inkjet head device, comprising:
a movement mechanism; and
an inkjet head mounted to the movement mechanism and configured to dispense a liquid in a first direction, wherein
the movement mechanism is configured to translate the inkjet head in a second direction crossing the first direction,
the inkjet head includes:
a piezoelectric element configured to change a volume of a pressure chamber;
a first switch configured to connect the piezoelectric to a first power line at a first voltage when turned on; and
a control circuit configured to turn on the first switch at a first change time and then turn off the first switch after the voltage of the piezoelectric element reaches the first voltage and then turn on the first switch before a second change time, and
the control circuit applies a drive waveform to the piezoelectric element in which the voltage of the drive waveform is a second voltage before the first change time, the first voltage after the first change time, and the second voltage after the second change time.

10. The inkjet head device according to claim 9, further comprising:
a second switch configured to connect the piezoelectric element to a second power line at the second voltage when turned on, wherein
the control circuit is configured to turn the second switch on and then off before the first change time.

11. The inkjet head device according to claim 10, wherein the control circuit turns the first switch on and off between the first and second change times.

12. The inkjet head device according to claim 9, wherein
a length of time between the first and second change times of the drive waveform is at least three acoustic lengths (AL) of the pressure chamber.

13. The inkjet head device according to claim 9, wherein
the piezoelectric element includes a first electrode and a second electrode,
the first electrode is connected to the first switch, and
the second electrode is connected to a reference voltage terminal.

14. The inkjet head device according to claim 13, further comprising:
a second switch configured to connect the first electrode of the piezoelectric element to a second power line at the second voltage when turned on, wherein
the control circuit is configured to turn the second switch on and then off before the first change time.

15. The inkjet head device according to claim 14, further comprising:
a third switch configured to connect the first electrode of the piezoelectric element to a third power line when at a third voltage when turned on, the third voltage being less than the first voltage but greater than the second voltage.

16. The inkjet head device according to claim 9, wherein the first switch comprises a transistor.

17. An inkjet recording apparatus for dispensing an ink droplet, the inkjet recording apparatus comprising:
an inkjet head configured to dispense ink towards a target medium; and
a support mechanism configured to support the target medium, wherein
the inkjet head includes:
a piezoelectric element configured to change a volume of a pressure chamber;
a first switch configured to connect the piezoelectric to a first power line at a first voltage when turned on; and
a control circuit configured to turn on the first switch at a first change time and then turn off the first switch after the voltage of the piezoelectric element reaches the first voltage and then turn on the first switch before a second change time, and
the control circuit applies a drive waveform to the piezoelectric element in which the voltage of the drive waveform is a second voltage before the first change time, the first voltage after the first change time, and the second voltage after the second change time.

18. The inkjet recording apparatus according to claim 17, further comprising:
a movement mechanism, wherein
the inkjet head is mounted to the movement mechanism and configured to dispense a liquid in a first direction toward the target medium, and
the movement mechanism is configured to translate the inkjet head in a second direction crossing the first direction.

19. The inkjet recording apparatus according to claim 17, further comprising:
a second switch configured to connect the piezoelectric element to a second power line at the second voltage when turned on, wherein
the control circuit is configured to turn the second switch on and then off before the first change time.

20. The inkjet recording apparatus according to claim 17, wherein the control circuit turns the first switch on and off between the first and second change times.
